(19) United States
(12) Patent Application Publication
(10) Pub. No.: US 2026/0265603 A1
(43) Pub. Date: Sep. 10, 2026

(54) METHOD FOR INJECTING AN AQUEOUS POLYMER SOLUTION INTO AN UNDERGROUND FORMATION

(71) Applicant: SNF Group, ANDREZIEUX BOUTHEON (FR)

(72) Inventor: Cédrick FAVERO, ANDREZIEUX BOUTHEON (FR)

(73) Assignee: SNF Group, ANDREZIEUX BOUTHEON (FR)

(21) Appl. No.: 19/164,975

(22) PCT Filed: Mar. 13, 2024
(86) PCT No.: PCT/EP2024/056692

§ 371 Date: Sep. 12, 2025

(30) Foreign Application Priority Data
Mar. 14, 2023 (EP) 23161906.5

(51) Int. Cl. C09K 8/68; C09K 8/588; C09K 8/66

(52) U.S. Cl. CPC C09K 8/68; C09K 8/588; C09K 8/665

(57) ABSTRACT

The present invention relates to a method for injecting an aqueous solution of a 2-acrylamido-2-methylpropanesulfonate homopolymer P and/or its salts having an average molecular weight greater than 1 million daltons, said method comprising the following successive steps:
in a location A:
   preparation in a mobile unit U1 of sodium 2-acrylamido-2-methylpropanesulfonate in crystalline form (AMPS.S),
   collection of an AMPS.OS sodium 2-acrylamido-2-methylpropanesulfonate aqueous solution S1, coming from the purge of the preparation of the AMPS.s in the mobile unit U1,
in a location A′:
   preparation in a mobile unit U3 of a homopolymer P by gel polymerisation of an AMPS.S aqueous solution S3,
   dissolution in a mobile unit U4 of the polymer P in a saline solution SS1 to obtain a polymer P solution SM,
   transfer of the solution SM from the location A′ to a location B,
in the location B:
   dilution in a mobile unit U5 of the solution SM by a saline solution SS2 to obtain a solution SF,
   injection of the solution SF in the underground formation for the assisted extraction of hydrocarbons or hydraulic fracturing.

### FIELD OF THE INVENTION

The invention relates to a method for injecting a sodium or potassium or ammonium 2-acrylomido-2-methylpropanesulfonate homopolymer aqueous solution into an underground formation for the assisted extraction of hydrocarbons (oil and/or gas) or hydraulic fracturing.

More specifically, the method relates to the field of preparing polymer solution on fields in modular units for its direct injection into the underground formation.

### PRIOR ART

Patent applications FR2302305, FR2302307 and FR2302310 of the Applicant highlight the interest of injecting sodium or potassium 2-acrylamido-2-methylpropanesulfonate polymer saline solutions crystalline form into underground formations for the assisted recovery of hydrocarbons (oil and/or gas) or hydraulic fracturing.

For oil or gas assisted recovery techniques, these polymers have improved properties in terms of filterability and chemical and thermal stability.

For hydraulic fracturing, sodium or potassium 2-acrylomido-2-methylpropanesulfonate-based synthetic polymers in hydrated form make it possible to have a very high friction reduction effect, while guaranteeing an improved viscosifying effect in a saline solution (brine). In addition, the good solubility of the polymer in the fracturing fluid, combined with its sulfonic anionic character, makes it possible to avoid its adsorption on the rock, which induces a recovery of conductivity and therefore an increase in the hydrocarbon production yield (oil and/or gas).

However, the synthesis of the sodium or potassium 2-acrylomido-2-methylpropanesulfonate-based polymers in hydrated form is done on manufacturing sites, which are far from the injection wells leading to these underground formations, and due to this, involves expensive logistics which consume a lot of energy to send the polymers at the hydrocarbon development fields.

The physical form of the polymer which makes it possible to have the greatest mass concentration in active material to supply the fields for the EOR or for the hydraulic fracturing is powder. However, this physical form involves specific dissolution units (PSU: Polymer Slicing Unit, maturation tanks, see document WO 2008/071808), which are expensive and consume a lot of energy.

Moreover, the powder comes from a polymerisation gel method, which involves an operation of drying the polymer gel to transform it into powder (U.S. Pat. No. 5,633,329). 1 to 5 volumes of water must typically be evaporated for 1 volume of powder, which involves increasing water and energy consumption, and therefore increasing the carbon footprint of the product.

### SUMMARY OF THE INVENTION

The Applicant has thus developed a method for preparing sodium or potassium or ammonium 2-acrylomido-2-methylpropanesulfonate homopolymer solutions and/or its salts based on modular units in order to be able to carry out all the preparation steps on fields in the proximity of the underground formations to be developed.

This method includes (1) the preparation of sodium or potassium or ammonium 2-acrylomido-2-methylpropanesulfonate in hydrated form in a first location, (2) the synthesis of the polymer and the preparation of a concentrated polymer solution in a second location and finally (3) the dilution of this solution for injection into the underground formation in the third location.

This method makes it possible to manufacture, in a continuous flow, the required quantity of injection solution. In addition, it makes it possible to considerably decrease the logistics costs (transport, dissolution of the polymer) with a low water and carbon footprint (no drying) and it can be transposed over any fields and under any field conditions (saltiness, hardness, temperature, etc.) without needing installations classified as high-risk (chemical).

The only monomer to be sent and to be possibly stored on the first location is 2-acrylamido-2-methylpropane sulfonic acid (AMPS) or one of its salts. This monomer, contrary to monomers such as acrylonitrile, acrylamide or acrylic acid, has the advantage of being in solid form and therefore of not having a risk of leakage or of spreading. In addition, it is not toxic (CMR) and remains stable in the solid state according to the temperature (not temperature-sensitive). Finally, another advantage of AMPS, or one of its salts, compared with acrylamide, is that it can be polymerised at a higher concentration and without needing prior cooling, as less exothermal, which generates energy gains and makes the claimed method transposable anywhere, including in dry zones or with a seasonal water stress.

As an illustration, 1 volume of acrylamide and/or acrylic acid requires to be polymerised in the presence of at least 3 volumes of water and with a prior cooling to 0° C. while the AMPS or one of its salts only requires 1 to 2 volumes of water with a start of polymerisation in solution at the ambient temperature.

### Presentation of the Invention

More specifically, the invention relates to a method for injecting a sodium or potassium or ammonium 2-acrylomido-2-methylpropanesulfonate homopolymer P aqueous solution and/or its salts, the homopolymer P having an average molecular weight by weight greater than 1 million daltons, the homopolymer P aqueous solution being injected into an underground formation for the assisted extraction of hydrocarbons (oil and/or gas) or hydraulic fracturing, said method comprising the following successive steps:
in a location A:
   preparation in a mobile unit U1 of sodium or potassium or ammonium 2-acrylamido-2-methylpropanesulfonate in crystalline form (AMPS.S),
sodium 2-acrylamido-2-methylpropanesulfonate in crystalline form having a powder X-ray diffraction pattern comprising peaks at 11.7°; 12.2°; 13.2°; 13.5°; 15.6°; 16.8°; 17.8°; 18.5°; 19.1°; 20.6°; 21.4°; 23.3°; 25.1°; 25.8°; 26.9°; 29.1°; 29.5°; 31.0°; 33.0°; 33.6°; 34.4°; 35.2°; 35.9°; 37.1°; 38.4°; 39.6°; 41.1°; 42.9°; 45.1°; 46.0°; 47.2°; 47.6°, 2-theta degrees,
potassium 2-acrylamido-2-methylpropanesulfonate in crystalline form having a powder X-ray diffraction pattern comprising peaks at 13.1°; 14.4°; 16.3°; 19.8°; 23.5°; 24.3°; 26.9°; 27.6°; 29.3°; 30.6°; 31.6°; 34.3°; 36.1°; 41.7°; 44.6°; 46.7°, degrees 2-theta,
ammonium 2-acrylamido-2-methylpropanesulfonate in crystalline form having a powder X-ray diffraction pattern comprising peaks at 10.1°; 13.1°; 13.2°; 17.5°; 15.6°; 18.1°; 19.5°; 20.0°; 21.4°; 22.8°; 23.6°; 24.8°; 25.1°; 25.8°; 26.2°; 27.4°; 28.1°; 29.4°; 30.2°; 30.8°; 32.0°; 32.9°; 33.2°; 33.9°; 34.4°; 35.0°; 36.2°; 37.7°; 38.8°; 39.6°; 40.4°; 41.4°; 41.9°; 42.8°; 43.5°; 44.8°; 45.5°; 45.7°; 46.5°; 47.0°; 47.4°, degrees 2-theta,
   collection of an aqueous solution S1 of sodium or potassium or ammonium 2-acrylamido-2-methylpropanesulfonate AMPS.OS, coming from the purge of the AMPS.S preparation in the mobile unit U1,
in a location A′:
   preparation in a mobile unit U3 of a homopolymer P by gel polymerisation of an AMPS.S aqueous solution S3,
   dissolution in a mobile unit U4 of the polymer P in a saline solution SS1 containing at least 1 g/L of alkaline and/or alkaline earth salts in water to obtain a polymer P solution SM,
   transfer of the solution SM from the location A′ to a location B,
in the location B:
   dilution in a mobile unit U5 of at least a factor 4 and as a maximum a factor 60 of the solution SM by a saline solution SS2 containing at least 1 g/L of alkaline and/or alkaline earth salts in water to obtain an aqueous solution SF containing less than 0.6% by weight of polymer P,
   Injection of the solution SF into the underground formation.

In this process:
in the location A: polymerisation (in solution, example of a method: document US 2013090425) in a unit U2 of the AMPS.OS solution S1 collected in the mobile unit U1 to obtain an aqueous polymer P′ solution S2,
transfer through pipes of the solution S2 from the unit U2 of the location A to the mobile unit U3 of the location A′,
in the location A′: preparation in a mobile unit U3, before the polymerisation of AMPS.S, of a composition CA′ comprising the AMPS.S solution S3 and at least some of the polymer P′ solution S2, the mass ratio [P′]/[AMPS.S] being of between 0.05 and 0.20, with [P′] concentration by weight of polymer P′ in the composition CA′ and [AMPS.S] concentration by weight of AMPS.S in the composition CA′.

The ranges of values include the lower and upper limits. Thus, the ranges of values “between 0.1 and 1.0” and “from 0.1 to 1” include the values 0.1 and 1.0.

In general, the uncertainty of the peaks of the X-ray powder diffraction diagrams is generally of the order of +/−0.1°.

According to the present invention, the average molecular weight by weight of the polymer P is determined by measuring the intrinsic viscosity. The intrinsic viscosity can be measured by methods known to a person skilled in the art and can, in particular, be calculated from reduced viscosity values for different concentrations by a graphic method consisting of tracing the reduced viscosity values (on the y-axis) according to the concentrations (on the x-axis) and by extrapolating the curve at a zero concentration. The intrinsic viscosity value is read on the y-axis or by using the least-squares method. Then, the average molecular weight by weight can be determined by the famous Mark-Houwink equation:

$$[ η ] = K {M}^{α}$$

[η] represents the intrinsic viscosity of the polymer determined by the method for measuring the viscosity in solution,
K represents an empirical constant,
M represents the molecular weight of the polymer,
α represents the Mark-Houwink coefficient,
α and K depend on the particular polymer-solvent system. Tables known to a person skilled in the art give α and K values according to the polymer-solvent system.

The location A is advantageously a location comprising at least one mobile storage unit, at least one mobile mixture unit and at least one mobile filtration unit. Thus, the location A advantageously makes it possible to have clean water for the radical polymerisation of the APMS.S (for example, water coming from a method for treating industrial water and/or rainwater).

Preparing the sodium 2-acrylamido-2-methylpropanesulfonate in crystalline form is done according to the method described in patent application FR2302303.

The present invention also relates to the method for producing the crystalline form of the sodium salt of 2-acrylamido-2-methylpropanesulphonic acid comprising at least the following successive steps:
1) mixing of 2-acrylamido-2-methylpropanesulphonic acid with an aqueous solution SA_{Na-1} and at least one sodium salt, advantageously for at least 1 minute, in order to form an aqueous solution or an aqueous suspension SA_{Na-2};
2) distillation, at a pressure lower than atmospheric pressure, of the aqueous solution or of the aqueous suspension SA_{Na-2} in order to form a suspension S_{Na-1};
3) solid-liquid separation of the suspension S_{Na-1} and isolation of the crystals of the suspension S_{Na-1} obtained at the end of step 2) in the form of a composition C_{Na-1}.

The crystals obtained are in the crystalline form of the sodium salt of 2-acrylamido-2-methylpropanesulphonic acid.

“Sodium salt(s)” in the aqueous solution or suspension SA₂ should be understood to mean at least one inorganic salt, for example sodium hydroxide, sodium carbonate, sodium bicarbonate or mixtures thereof.

Preparing potassium 2-acrylamido-2-methylpropanesulfonate in crystalline form is done according to the method described in patent application FR2302310.

The present invention also relates to the method for producing the crystalline form of the potassium salt of 2-acrylamido-2-methylpropanesulphonic acid comprising at least the following successive steps:
1) mixing of 2-acrylamido-2-methylpropanesulphonic acid with an aqueous solution SA_{K-1} and at least one potassium salt, advantageously for at least 1 minute, in order to form an aqueous solution or an aqueous suspension SA_{K-2};
2) distillation, at a pressure lower than atmospheric pressure, of the aqueous solution or of the aqueous suspension SA_{K-2} in order to form a suspension S_{K-1};
3) solid-liquid separation of the suspension S_{K-1} and isolation of the crystals of the suspension S_{K-1} obtained at the end of step 2) in the form of a composition C_{K-1}.

The crystals obtained are in the crystalline form of the potassium salt of 2-acrylamido-2-methylpropanesulphonic acid.

“Potassium salt(s)” in the aqueous solution or suspension SA_{K-2} should be understood to mean at least one inorganic salt, for example potassium hydroxide, potassium carbonate, potassium bicarbonate or mixtures thereof.

The preparation of ammonium 2-acrylamido-2-methylpropanesulfonate (CH₂═CH—C(═O)—NH—C(CH₃)₂—CH₂—S(═O)₂O^{- +}NH₄) in crystalline form is carried out according to a process comprising at least the following successive steps:
1) Tubing of gaseous ammonia into a solution or suspension of 2-acrylamido-2-methylpropanesulphonic acid in order to form a solution S_{NH4-1};
2) Optionally evaporate water (advantageously under atmospheric pressure or under vacuum);
3) cooling of the aqueous solution S_{NH4-1} in order to obtain a suspension S_{NH4-2} of ammonium 2-acrylamido-2-methylpropanesulphonate crystals;
4) solid-liquid separation of the suspension S_{NH4-2} and isolation of the crystals of the suspension S_{NH4-2} obtained at the end of step 3) in the form of a composition C_{NH4-1}.

The mobile unit U1 advantageously comprises at least one mixture subunit and at least one filtration subunit. These subunits are known to a person skilled in the art and can correspond to those described in document WO 2018/172676 and the patent application FR 2302303.

This mobile unit U1 is a delocalisable modular unit which can be transported by lorry or by rail transport.

This mobile unit U1 contains a mobile storage subunit to collect the AMPS.OS solution S1. This solution S1 comes from the draining of the AMPS.S preparation and is therefore constituted of a mixture of the filtrates and of the solutions for washing the AMPS.S crystals (crystalline form of AMPS salt). The mobile storage subunit is preferably a tank.

Preferably, the AMPS.S is prepared by purification of 2-acrylamido-2-methylpropane sulfonic acid in powder form previously stored in the location A in a mobile storage unit located in the proximity of the mobile unit U1 (and therefore distinct from the mobile storage subunit). This storage unit is replenished by lorry or rail transport from production sites of 2-acrylamido-2-methylpropane sulfonic acid which could be distant from the location by several tens or hundreds of kilometres. The mobile storage unit in the proximity of the mobile unit U1 can have any shape and orientation. It can be, for example, cylindrical or rectangular and oriented horizontally or vertically. The volume and the dimensions are only limited by the condition that the storage units can be moved.

Advantageously, the 2-acrylamido-2-methylpropane sulfonic acid in powder form stored in the mobile storage unit in the location A has been previously obtained on its production site by a reaction between acrylonitrile, fuming sulfonic acid and iso-butylene containing less than 1000 ppm of butadiene and less than 100 ppm of butene (document WO 201746546).

The X ray powder diffraction diagrams for AMPS.S are done conventionally by X ray crystallography, X ray radiocrystallography or diffractometry. An example of a piece of equipment is a Rigaku-brand Miniflex II diffractometer equipped with a copper source.

Advantageously, the location A′ is a location which makes it possible to install at least one mobile storage unit, at least one mobile polymerisation unit and at least one mobile dilution unit. Thus, the location A′ advantageously makes it possible to have clean water for the radical polymerisation of APMS.S (for example, water coming from a method for treating industrial water and/or rainwater), but also water of a lesser quality for preparing aqueous solutions (in particular, SS1 or SS2).

The mobile unit U3 is advantageously composed of at least one polymerisation subunit such as a reactor in inverted conic tubular shape (inverted cone). Thus polymerisation subunit makes it possible to discharge the polymer gel by application of an air pressure on the surface of the gel or in the form of a tipper which discharges the gel mass by making the reactor tip. Advantageously, this mobile unit U3 also contains storage subunits for additives necessary for gel polymerisation (generally, one storage unit per additive). These additives are, for example, initiators (oxidiser/reducer, azos), polymerisation regulators, enzyme (glucose oxidase). The polymerisation additives and the gel polymerisation conditions are known to a person skilled in the art. The features of each storage unit are adapted to the physico-chemical properties and to the quantities of the different additives. The mobile unit U3 is a delocalisable modular unit which can be transported by lorry or by rail transport.

Preferably, the polymerisation of the AMPS.S solution S3 in composition CA′ in the mobile unit U3 is done with an initial concentration (before mixing S2 and S3) of AMPS.S in the solution S3 greater than 20% by weight, even more preferably greater than 30% by weight, and even more preferably, greater than 40% by weight. The initial concentration of AMPS.S in the solution S3 is advantageously less than 70% by weight.

Advantageously, the initial polymerisation temperature is the ambient temperature, namely between 15 and 30° C., and the final polymerisation temperature of the AMPS.S solution S3 in composition CA′ in the mobile unit U3 is greater than 80° C. A person skilled in the art will know how to adapt the polymerisation conditions to reach this temperature.

Preferably, the gel polymerisation of the AMPS.S solution S3 in composition CA′ within the mobile unit U3 is initiated in the presence of glucose oxidase. The radical polymerisation requires the absence of any oxygen traces in the polymerisation environment. The glucose oxidase is intended to deoxygenate the solution S3. The use of bubbling with inert gases such as nitrogen or argon is therefore generally useless in the presence of glucose oxidase. This reduces the need, all the more, of locally producing high energy-consuming inert gases and atmospheric releases, sources of pollution.

The polymer P coming from the gel polymerisation in the mobile unit U3 is dissolved in a mobile unit U4 in a saline solution SS1 containing at least 1 g/L of alkaline and/or alkaline earth salts in water to obtain a polymer P solution SM.

The mobile unit U4 is a delocalisable modular unit which can be transported by lorry or by rail transport.

In a preferred embodiment, at the end of preparing the polymer P by gel polymerisation of the AMPS.S solution S3 in composition CA′ in the mobile unit U3, the polymer P gel obtained is granulated in a granulation subunit to obtain polymer P gel pieces, which are directly dissolved in the solution SS1 to obtain the solution SM in the mobile unit U4.

The size of the aqueous polymer P gel pieces at the end of granulation is not specifically limited. In an embodiment of the invention, the granulated aqueous polyacrylamide gel pieces advantageously have a size such as at least two dimensions (length and diameter in the case of pieces in the form of cylindrical granules) are not greater than 1 cm, preferably not greater than 0.5 cm. Preferably, three dimensions (width, length and height in the case of parallelepiped-shaped pieces) of the aqueous polyacrylamide gel pieces should not be greater than 1 cm, preferably not greater than 0.5 cm. No lower limit is necessary for the aqueous polyacrylamide gel pieces, as the smaller the pieces are, the more easily the polymer dissolves. Generally, the aqueous polyacrylamide gel pieces can have a size such that the three dimensions are as low as 0.1 cm. Often, the aqueous polyacrylamide gel pieces tend to have three dimensions, each of between 0.1 cm and 0.5 cm.

In principle, any type of granulation means can be used to granulate the water-soluble polymer gel into smaller pieces. Examples of suitable means include cutting devices, such as cutters or perforated plates, crushers, kneaders, static or dynamic mixers, or water jets. A person skilled in the art will choose the suitable means and its conditions of use to obtain the gel pieces of predetermined sizes and shapes.

Advantageously, the polymer P gel pieces obtained at the end of granulation are directly added into a dissolution tank of the mobile unit U4. In this case, the dissolution in the saline solution SS1 is accelerated by means of a stirring blade. The gel pieces can also be dissolved within a conduit equipped with, or not, static or dynamic mixers. The combination of a conduit and a dissolution tank is also possible. Advantageously, the polymer P gel pieces are not stored between granulation and dissolution.

Advantageously, between the mobile units U3 and U4, the polymer P in the form of gel is conveyed by a screw conveyor to be granulated in a granulation subunit.

Preferably, the saline solution SS1 or SS2 contains between 1 g/L and 350 g/L of alkaline and/or alkaline earth salts in water, even more preferably between 10 g/L and 300 g/L.

Preferably, the saline solution SS1 or SS2 is drawn directly within the location A. As an example, this solution SS1 or SS2 can be seawater drawn within an offshore oil platform.

The saline solution SS1 can optionally be prepared within the mobile unit U4 in a dissolution tank and/or in a conduit equipped with static and/or dynamic mixers by adding the required quantities of salts to the water. The solution SS1 or SS2 preferably contains sodium (alkaline salt) and/or calcium (alkaline earth salt), for example a salt chosen from among calcium chloride, calcium bromide, sodium chloride, and their mixtures.

Advantageously, the mobile unit U4 comprises at least one dissolution subunit, for example a tank provided with a stirring blade and/or a conduit provided with mixers. Advantageously, it also comprises a tank for storing the saline solution SS1.

During the preparation of the solution SS1 or SS2, various compounds known to a person skilled in the art can be added, like those cited in document SPE 152596. Thus, the solution SS1 or SS2 can comprise, for example:
Clay anti-swelling agents such as potassium chloride or choline chloride, and/or
Biocides for preventing the development of bacteria, in particular sulphate-reducing bacteria, which can form viscous masses reducing the passage surfaces. Examples include glutaraldehyde, which is the most used, or indeed formaldehyde or the isothiazolinones, and/or
Oxygen reducers such as ammonium bisulphite for preventing the destruction of the other components by oxidation and corrosion of the injection tubes, and/or
Anti-corrosion additives for protecting the tubes from oxidation by residual quantities of oxygen, with N,N dimethylformamide being preferred, and/or
Lubricants such as oil distillates, and/or
Iron chelating agents such as citric acid, EDTA (ethylene diamine tetra-acetic) acid, phosphonates, and/or
Antiscaling agents such as phosphates, phosphonates, polyacrylates or ethylene glycol.

For this mobile unit U4, no water treated for polymerisation is necessary for preparing the solution SS1. This unit can use oil production water (conditioned for injection) or aquifer water.

The location B is advantageously a location which makes it possible to install at least one mobile storage unit, at least one mobile dilution unit. The location B in particular makes it possible to inject a fluid into an underground formation to extract hydrocarbons (oil and/or gas).

The mobile unit U5 is advantageously a delocalisable unit composed of at least one dilution subunit, for example a tank provided with a stirring blade and/or a conduit equipped with static and/or dynamic mixers. Optionally, the mobile unit U5 comprises a tank for storing the solution SM.

The mobile unit U5 is a delocalisable modular unit which can be transported by lorry or by rail transport.

Within this mobile unit U5, the saline solution SM is diluted by at least a factor 4 and as a maximum a factor 60 by the saline solution SS2 to obtain a solution SF containing less than 0.6% by weight of polymer P. As an example, for a solution containing 60% by weight of polymer P, a dilution by a factor 4 corresponds to obtaining a solution containing 15% by weight of polymer P.

Preferably, the solution SF contains between 0.01% and 0.4% by weight of polymer P, even more preferably between 0.02% and 0.3% by weight of polymer P.

Like for the mobile unit U4, the saline solution SS2 can be prepared within the mobile unit U5, for example in a dissolution tank by adding the required quantities of salts to the water or by directly drawing the solution SS2 within the location B.

After having optionally been stored in a storage tank, the solution SF is injected into the underground formation in order to extract hydrocarbons (oil and/or gas). The recovery of hydrocarbons is done, either by sweeping the underground formation (conventionally assisted extraction of hydrocarbons), or thanks to the natural pressure of the hydrocarbons after a hydraulic fracturing operation (non-conventionally).

Thus, the injection of the solution SF into the underground formation is followed by a step of recovering hydrocarbons by assisted extraction by sweeping the underground formation by means of the solution SF, or by a step of recovering hydrocarbons by hydraulic fracturing of the underground formation by means of the solution SF.

According to a preferred embodiment, the injection method of the invention is performed with the locations A and A′ which overlap or which are contiguous. In other words, in this configuration, the 2 locations become one.

The injection method of the invention comprises the following steps:
in the location A: polymerisation (in solution, example of a method: document US 2013090425) in a unit U2 of the AMPS.OS solution S1 collected in the mobile unit U1 to obtain an aqueous polymer P′ solution S2,
transfer through pipes of the solution S2 from the unit U2 of the location A to the mobile unit U3 of the location A′,
in the location A′: preparation in a mobile unit U3, before the polymerisation of AMPS.S, of a composition CA′ comprising the AMPS.S solution S3 and at least some of the polymer P′ solution S2, the mass ratio [P′]/[AMPS.S] being of between 0.05 and 0.20, with [P′] concentration by weight of polymer P′ in the composition CA′ and [AMPS.S] concentration by weight of AMPS.S in the composition CA′.

The transfer of the AMPS.OS solution S1 from the storage subunit of the mobile unit U1 to the unit U2 is done preferably through a conduit (pipe).

The polymerisation of the AMPS.OS solution S1 in the unit U2 is a polymerisation in solution known to a person skilled in the art to obtain a polymer P′ of average molecular weight by weight advantageously of between 500 and 500000 daltons. Adding the polymer P′ solution S2 into the solution S3 is done preferably before adding redox and/or thermal and/or glucose oxidase initiators.

The unit U2 is a delocalisable modular unit which can be transported by lorry or by rail transport and which is composed of at least one polymerisation subunit, for example a tank provided with a stirring blade.

According to the distances between the locations A′ and B, the transfer of the solution SM from the location A′ to the location B is done by pipes or by transport units.

For example, the distances between the locations A′ and B can be between 10 and 3000 km, or between 10 and 1500 km, or between 20 and 500 km, or also between 30 and 300 km.

The pipes ensuring the transfer of the solution SM between the locations A′ and B are preferably rigid and can include static mixers.

For the transport of the solution SM between the locations A′ and B, a suitable transport unit is used. The transport unit can have a volume of 1 m³ to 40 m³, in particular of 5 m³ to 40 m³, preferably of 10 to 30 m³, for example of 20 m³ to 30 m³ or of 15 to 25 m³. Examples of suitable transport units comprise ships comprising at least one opening or tank containers.

The transport of the solution SM between the locations A′ and B can be done by any type of transport means suitable for transporting the transport unit, for example by lorries, carriages or ships.

The term “transport unit” means one or more advantageously distinct transport units such as containers, for example ISO containers or intermediate loose containers, which are loaded on suitable transport means, for example trailers, container carriages or ships. The transport means can transport one single transport unit or a plurality of transport units. The term “transport unit” further includes the transport units in which the transport compartment is temporarily or permanently fixed to the transport means, like for example tankers or tank cars.

In an embodiment, the transport is done by lorries. The transport unit can also be fixed to a lorry. In an embodiment, the transport unit can be an ISO tank container.

In an embodiment, tanks fixed to a lorry can be used. In an embodiment, the reservoir comprises an outlet opening at the rear end of the lorry and, to facilitate the removal of the contents, the reservoir can be inclined. In an embodiment, the reservoir comprises an outlet opening on the lower side of the reservoir. Furthermore, the tank can comprise a cone on the lower side of the tank and the outlet opening is located at the lower end of the cone. Filling the transport unit with the solution SM can be done by pumping the solution SM into the transport unit.

The transport time, i.e. the transport time of the transport unit filled with polymer P solution SM, can be very different, according to the distance between the locations A′ and B. It can vary by a few minutes to several days, for example from 1 hour to 28 days, in particular from 2 hours to 14 days, in particular from 5 hours to 7 days. In an embodiment of the invention, a homogenisation step such as described below can be carried out during transport. In an embodiment, the transport unit, for example a lorry, can comprise a rotary drum making it possible to perform the homogenisation. In embodiments, the transport unit can comprise a circulation loop equipped with a pump and optionally mixture units, for example static mixers, such that the polymer P solution SM can be circulated during transport.

Advantageously the polymer P solution SM in the location A′ is stored in a maturation and storage unit before being transferred to the location B. This maturation and storage unit is advantageously constituted of one or more tanks in series provided with stirring blades.

### FIGURES

FIG. 1 represents the present invention according to which the AMPS.S monomer is polymerised in the presence of polymer P′.

### DESCRIPTION OF THE FIGURES

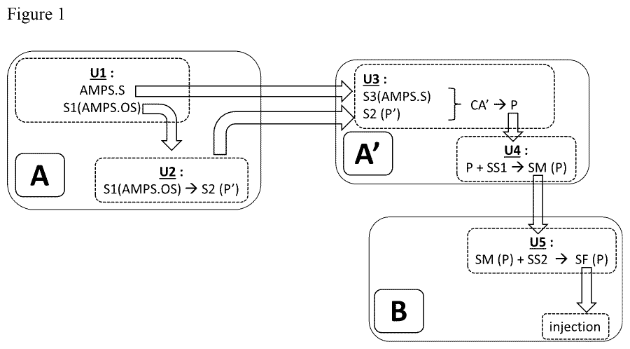

The device of FIG. 1 comprises:
a location A including:
   the preparation in a mobile unit U1 of AMPS.S,
   the collection of the AMPS.OS aqueous solution S1, coming from the draining of the preparation of the AMPS.S,
a location A′ including:
   the preparation in a mobile unit U3 of a homopolymer P by gel polymerisation of an AMPS.S aqueous solution S3 in a composition CA′,
   the preparation in a mobile unit U3, before the polymerisation of AMPS.S, of a composition CA′ containing the AMPS.S solution S3 and at least some of the polymer P′ solution S2,
   the dissolution in a mobile unit U4 of the polymer P in a saline solution SS1 to obtain a polymer P solution SM,
   the transfer of the solution SM from the location A′ to a location B,
   the polymerisation (in solution) in a unit U2 of the AMPS.OS solution S1 to obtain a polymer P′ aqueous solution S2,
the transfer of the solution S2 from the unit U2 of the location A to the mobile unit U3 of the location A′,
the location B including:
   the dilution in a mobile unit U5 of the solution SM by a saline solution SS2 to obtain a solution SF containing less than 0.6% by weight of polymer P,
   the injection of the solution SF into the underground formation.

1. A method for injecting a sodium or potassium or ammonium 2-acrylomido-2-methylpropanesulfonate homopolymer P aqueous solution and/or its salts, the homopolymer P having an average molecular weight by weight greater than 1 million daltons, the homopolymer P aqueous solution being injected into an underground formation for the assisted extraction of hydrocarbons or hydraulic fracturing, said method comprising the following successive steps:
in a location A:
preparing, in a mobile unit U1, of sodium or potassium or ammonium 2-acrylamido-2-methylpropanesulfonate in crystalline form (AMPS.S),
sodium 2-acrylamido-2-methylpropanesulfonate in crystalline form having a powder X-ray diffraction pattern comprising peaks at 11.70°; 12.20°; 13.2°; 13.5°; 15.60°; 16.80°; 17.80°; 18.5°; 19.1°; 20.6°; 21.4°; 23.3°; 25.1°; 25.8°; 26.9°; 29.10°; 29.50°; 31.0°; 33°; 33.6°; 34.4°; 35.2°; 35.9°; 37.1°; 38.4°; 39.6°; 41.10°; 42.90°; 45.10°; 46.0°; 47.2°; 47.6°, 2-theta degrees,
potassium 2-acrylamido-2-methylpropanesulfonate in crystalline form having a powder X-ray diffraction pattern comprising peaks at 13.10°; 14.4°; 16.3°; 19.8°; 23.50°; 24.3°; 26.9°; 27.6°; 29.3°; 30.6°; 31.6°; 34.3°; 36.1°; 41.7°; 44.6°; 46.7°, degrees 2-theta,
ammonium 2-acrylamido-2-methylpropanesulfonate in crystalline form having a powder X-ray diffraction pattern comprising peaks at 10.10°; 13.10°; 13.2°; 17.5°; 15.60°; 18.10°; 19.50°; 20.0°; 21.4°; 22.8°; 23.6°; 24.8°; 25.1°; 25.8°; 26.2°; 27.4°; 28.10°; 29.4°; 30.2°; 30.8°; 32.0°; 32.9°; 33.2°; 33.9°; 34.4°; 35.0°; 36.2°; 37.7°; 38.8°; 39.6°; 40.4°; 41.4°; 41.9°; 42.8°; 43.5°; 44.8°; 45.5°; 45.7°; 46.5°; 47.0°; 47.4°, degrees 2-theta,
collecting of an aqueous solution S1 of sodium or potassium or ammonium 2-acrylamido-2-methylpropanesulfonate AMPS.OS, coming from the purge of the AMPS.S preparation in the mobile unit U1,
polymerizing, in a unit U2, the AMPS.OS solution S1 collected in the mobile unit U1 to obtain a polymer P′ aqueous solution S2,
transferring by pipes the solution S2 from unit U2 of location A to a mobile unit U3 of a location A′,
in the location A′:
preparing, in a mobile unit U3, a composition CA′ containing an AMPS.S solution S3 and at least some of the polymer P′ solution S2, the mass ratio [P′]/[AMPS.S] being of between 0.05 and 0.20, with [P′] concentration by weight of polymer P′ in the composition CA′ and [AMPS.S] concentration by weight of AMPS.S in the composition CA′,
preparing, in the mobile unit U3, a homopolymer P by gel polymerisation of AMPS.S aqueous solution S3 in composition CA′,
dissolving, in a mobile unit U4, the polymer P in a saline solution SS1 containing at least 1 g/L of alkaline and/or alkaline earth salts in water to obtain a polymer P solution SM,
transferring the solution SM from the location A′ to a location B,
in the location B:
diluting, in a mobile unit U5, of at least a factor 4 and as a maximum a factor 60 of the solution SM by a saline solution SS2 containing at least 1 g/L of alkaline and/or alkaline earth salts in water to obtain a solution SF containing less than 0.6% by weight of polymer P, and
injecting of the solution SF into the underground formation.

2. The method according to claim 1, characterised in that the locations A and A′ overlap or are contiguous.

3. The method according to claim 1, characterised in that the transfer of the solution SM from the location A′ to the location B is done by pipes or by transport units.

4. The method according to claim 1, characterised in that the AMPS.S is prepared by purification of 2-acrylamido-2-methylpropane sulfonic acid previously stored in the location A in a mobile storage unit.

5. The method according to claim 1, characterised in that at the end of preparing the polymer P by gel polymerisation of the AMPS.S solution S3 in composition CA′ in the mobile unit U3, the polymer P gel obtained is granulated in a granulation unit to obtain polymer P gel pieces, which are directly dissolved in the saline solution containing at least 1 g/L of alkaline and/or alkaline earth salts to obtain the solution SM in the mobile unit U4.

6. The method according claim 1, characterised in that the polymerisation of the polymer P in the mobile unit U3 is initiated in the presence of glucose oxidase.

7. The method according to claim 1, characterised in that the solution SM at the location A′ is stored in a maturation and storage unit before being transferred to the location B.

8. The method according to claim 1, characterised in that the polymerisation of the AMPS.S solution S3 in composition CA′ in the mobile unit U3 is done with an initial concentration of AMPS.S in the solution S3 greater than 20% by weight.

9. The method according to claim 1, characterised in that the final temperature of the polymerisation of the AMPS.S solution S3 in composition CA′ in the mobile unit U3 is greater than 80° C.

10. The method according to claim 1, characterised in that the injection of the solution SF into the underground formation is followed by a step of recovering hydrocarbons by assisted extraction by sweeping the underground formation by means of the solution SF.

11. The method according to claim 1, characterised in that the injection of the solution SF in the underground formation is followed by a step of recovering hydrocarbons by hydraulic fracturing of the underground formation by means of the solution SF.

12. The method according to claim 3, characterised in that the polymer P′ has an average molecular weight by weight of between 500 and 500000 Daltons.

13. The method according to claim 2, characterised in that the transfer of the solution SM from the location A′ to the location B is done by pipes or by transport units.

14. The method according to claim 2, characterised in that the AMPS.S is prepared by purification of 2-acrylamido-2-methylpropane sulfonic acid previously stored in the location A in a mobile storage unit.

15. The method according to claim 3, characterised in that the AMPS.S is prepared by purification of 2-acrylamido-2-methylpropane sulfonic acid previously stored in the location A in a mobile storage unit.

16. The method according to claim 2, characterised in that at the end of preparing the polymer P by gel polymerisation of the AMPS.S solution S3 in composition CA′ in the mobile unit U3, the polymer P gel obtained is granulated in a granulation unit to obtain polymer P gel pieces, which are directly dissolved in the saline solution containing at least 1 g/L of alkaline and/or alkaline earth salts to obtain the solution SM in the mobile unit U4.

17. The method according claim 16, characterised in that the polymerisation of the polymer P in the mobile unit U3 is initiated in the presence of glucose oxidase.

18. The method according to claim 17, characterised in that the solution SM at the location A′ is stored in a maturation and storage unit before being transferred to the location B.

19. The method according to claim 18, characterised in that the polymerisation of the AMPS.S solution S3 in composition CA′ in the mobile unit U3 is done with an initial concentration of AMPS.S in the solution S3 greater than 20% by weight.

20. The method according to claim 5, characterised in that the polymer P′ has an average molecular weight by weight of between 500 and 500000 Daltons.
